(19) United States
(12) Patent Application Publication
(10) Pub. No.: US 2026/0029597 A1
(43) Pub. Date: Jan. 29, 2026

(54) METHODS FOR PRECISION ALIGNMENT OF MICRO-ELECTRO-MECHANICAL SYSTEM (MEMS) MICRO-MIRRORS OF OPTICAL PRINTED CIRCUIT BOARD (PCB)

(71) Applicant: TTM Technologies, Inc., Santa Ana, CA (US)

(72) Inventors: David Senk, Brookdale, CA (US); Marika Immonen, Vantaa (FI)

(73) Assignee: TTM Technologies, Inc., Santa Ana, CA (US)

(21) Appl. No.: 18/785,880

(22) Filed: Jul. 26, 2024

(51) Int. Cl. G02B 6/42; G02B 26/08; G02B 26/10

(52) U.S. Cl. CPC G02B 6/4286; G02B 6/4227; G02B 26/0833; G02B 26/101

(57) ABSTRACT

A device may perform a first full-matrix optical scan covering a first scan area and having a first resolution to identify a first maximum power spot within a region where the optical signal is detected when a first MEMS micro-mirror and a second MEMS micro-mirror are concurrently at their respective first maximum power positions. The device may perform a second full-matrix optical scan centered around the first maximum power spot, the second full-matrix optical scan covering a second scan area smaller than the first scan area and having a second resolution finer than the first resolution. The device may identify a second maximum power spot within the first maximum power spot when the first MEMS micro-mirror and the second MEMS micro-mirror are concurrently at their respective second maximum power positions. The device may lock the respective second maximum power positions of the first MEMS micro-mirror and the second MEMS micro-mirror.

### TECHNICAL FIELD

The present disclosure relates generally to an optical Printed Circuit Board (PCB) including a PCB integrated with a waveguide that couples between a transmitter and a receiver via optical coupling elements. Specifically, the present disclosure relates generally to precision alignment of the waveguide with the transmitter and receiver via dynamically adjusting Micro-Electro-Mechanical System (MEMS) micro-mirrors.

### BACKGROUND

To have a mass-production of an optical printed circuit board (PCB), the light from a transmitter (Tx) needs to reliably and consistently get into a planar waveguide or optical fiber embedded in the PCB and then comes out of the planar waveguide or embedded optical fiber to a receiver (Rx) with minimum loss of optical power. There remains a need for systems and methods that can achieve precision autonomous, dynamic, active alignment of the waveguide with the transmitter and receiver.

### BRIEF SUMMARY

In one aspect, a method is provided for automatic alignment of a system including a first optical component, a second optical component, a waveguide, and one or more micro-electromechanical system (MEMS) mirrors. The method may include performing a first full-matrix optical scan covering a first scan area and having a first resolution, including steps (1)-(4), (1) controlling, by a controller, movements of a first MEMS micro-mirror to a first mirror position, the first MEMS micro-mirror coupled to a first optical component including a transmitter or a receiver, (2) dynamically controlling, by the controller, movements of a second MEMS micro-mirror to perform the first full-matrix optical scan, the second MEMS micro-mirror coupled to a second optical component including a receiver or a transmitter, (3) if the first or second optical component receives no optical signal, controlling movements of the first MEMS micro-mirror to a second mirror position, repeating step (2) until an optical signal is detected, (4) identifying a first maximum power spot within a region where the optical signal is detected when the first MEMS micro-mirror and the second MEMS micro-mirror are concurrently at their respective first maximum power positions. The method may also include performing a second full-matrix optical scan by repeating steps (1)-(4), where the second full-matrix optical scan is centered around the first maximum power spot, the second full-matrix optical scan covering a second scan area smaller than the first scan area and having a second resolution finer than the first resolution. The method may also include identifying a second maximum power spot within the first maximum power spot when the first MEMS micro-mirror and the second MEMS micro-mirror are concurrently at their respective second maximum power positions. The method may also include locking the respective second maximum power positions of the first MEMS micro-mirror and the second MEMS micro-mirror.

In some aspects, a non-transitory computer-readable storage medium is provided for automatic alignment of a system including a transmitter, a photodetector, a waveguide, and one or more micro-electromechanical system (MEMS) mirrors. The non-transitory computer-readable storage medium may include instructions that when executed by a computer, cause the computer to: perform a first full-matrix optical scan covering a first scan area and having a first resolution, including steps (1)-(4), (1) controlling, by a controller, movements of a first MEMS micro-mirror to a first mirror position, the first MEMS micro-mirror coupled to a first optical component including a transmitter or a receiver, (2) dynamically controlling, by the controller, movements of a second MEMS micro-mirror to perform the first full-matrix optical scan, the second MEMS micro-mirror coupled to a second optical component including a receiver or a transmitter, (3) if the first or second optical component receives no optical signal, controlling movements of the first MEMS micro-mirror to a second mirror position, repeating step (2) until an optical signal is detected, (4) identifying a first maximum power spot within a region where the optical signal is detected when the first MEMS micro-mirror and the second MEMS micro-mirror are concurrently at their respective first maximum power positions. The non-transitory computer-readable storage medium may include instructions that when executed by a computer, cause the computer to perform a second full-matrix optical scan by repeating steps (1)-(4), where the second full-matrix optical scan is centered around the first maximum power spot, the second full-matrix optical scan covering a second scan area smaller than the first scan area and having a second resolution finer than the first resolution. The non-transitory computer-readable storage medium may include instructions that when executed by a computer, cause the computer to identify a second maximum power spot within the first maximum power spot when the first MEMS micro-mirror and the second MEMS micro-mirror are concurrently at their respective second maximum power positions. The non-transitory computer-readable storage medium may include instructions that when executed by a computer, cause the computer to lock the respective second maximum power positions of the first MEMS micro-mirror and the second MEMS micro-mirror.

Additional aspects, embodiments, and features are outlined in part in the description that follows and will become apparent to those skilled in the art upon examination of the specification or may be learned by the practice of the disclosed subject matter. A further understanding of the nature and advantages of the disclosure may be realized by reference to the remaining portions of the specification and the drawings, which form a part of this disclosure.

### BRIEF DESCRIPTION OF THE DRAWINGS

In order to describe the manner in which the above-recited and other advantages and features of the disclosure may be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a system including an optical waveguide coupled between a transmitter and a receiver in accordance with some aspects of the present technology;

FIG. 2 illustrates an optical PCB including a PCB integrated with a waveguide via optical coupling elements in accordance with some aspects of the present technology;

FIG. 3 illustrates an optical PCB system including 90-degree-turn MEMS micro-mirrors in accordance with some aspects of the present technology;

FIG. 4 illustrates a block diagram for precision alignments of an optical PCB system by dynamically adjusting MEMS micro-mirrors using a controller in accordance with some aspects of the present technology;

FIG. 5 illustrates a coarse scan for optimizing positions of a first MEMS micro-mirror and a second MEMS micro-mirror of an optical PCB system in accordance with some aspects of the present technology;

FIG. 6 illustrates a fine scan for optimizing positions of the first MEMS micro-mirror and the second MEMS micro-mirror of the optical PCB system of FIG. 5 in accordance with some aspects of the present technology;

FIG. 7 illustrates a flow chart illustrating the steps for precision alignment of an optical PCB system in accordance with some aspects of the present technology; and

FIG. 8 shows an example of a computing system for implementing certain aspects of the present technology.

### DETAILED DESCRIPTION

The detailed description set forth below is intended as a description of various configurations of embodiments and is not intended to represent the only configurations in which the subject matter of this disclosure can be practiced. The appended drawings are incorporated herein and constitute a part of the detailed description. The detailed description may include specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure may be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Generally, an optical PCB may include a PCB integrated with a planar waveguide or an embedded optical fiber that couples between a transmitter and a receiver via optical coupling elements. The planar waveguide or embedded optical fiber needs to be precisely aligned with a transmitter and a receiver for a minimum loss. The alignment tolerances for the approach to work are approximately within +/−0.5 micron for single mode (SM) transmissions, and +/−1 microns for multi-mode (MM) transmissions. These optical alignment tolerances are much smaller than the alignment tolerance for a PCB. For example, typical PCB alignment tolerances may be about +/−100 microns, which is one to two orders of magnitude greater than that needed for the optical PCB system to function.

The disclosure addresses the needs of obtaining precision alignments of OPCB system for single mode transmissions and multi-mode transmissions. The present disclosure provides systems and methods for precision alignment of the waveguide with the transmitter and receiver via dynamically adjusting at least two Micro-Electro-Mechanical System (MEMS) micro-mirrors. The disclosure provides a controller for dynamically adjusting positions of MEMS micro-mirrors. The controller is also in communication with the receiver (e.g., photodetector) and the transmitter, e.g., vertical cavity surface emitter laser (VCSEL), or other types of lasers to enable much better alignment of the waveguide. The controller controls the transmitter to emit lights or to generate optical signals while the MEMS micro-mirrors may dynamically move in their positions. The receiver detects the lights and reports power outputs from the receiver to the controller.

The disclosure provides an optimization scan algorithm that breaks a large, high-resolution scan into one or more large, low-resolution scans and one or more small high-resolution scans to reduce a total time for optimizing the positions of the MEMS micro-mirrors. Each succeeding scan may be centered around a maximum power spot or scan spot from a preceding scan. The maximum power scan spot has the maximum power which is obtained when the first MEMS micro-mirror is at a maximum power position, and the second MEMS micro-mirror is at its maximum power position. In a first scan which is a large area, low resolution scan, the first and second MEMS mirrors locate the respective optimized positions at which the total received power is at a maximum. On subsequent scans, the scan area is reduced to a smaller area centered on the optimized positions from the first scan. The subsequent higher resolution scan in the smaller area then identifies new respective optimized positions at which the total received power is at a maximum. This process may be repeated to further optimize the maximum received power.

The disclosure provides a method for finding the optimum power by full-matrix scanning of both the first MEMS micro-mirror for a first optical component (e.g., transmitter) and then the second MEMS micro-mirror for a second optical component (e.g., receiver) at a coarse resolution or low resolution, then repeating the process of full-matrix scanning, possibly once, twice, or three or more times at an increasingly finer resolution of the power maximum identified by a previous coarser scan having a coarser resolution or lower resolution. The positions of the first and second MEMS micro-mirrors can be automatically controlled by using the optimization scan algorithm for optical channels in an optical printed circuit board. The optimization scan algorithm also allows to continuously adjust the mirror position and to lock the mirrors into positions that have a maximum received power.

The optical printed circuit board includes waveguides that can be glass or plastic, fiber or planar waveguides. The waveguides may be planar polymer or glass waveguides. The power optimization system may continuously run, or may run periodically, or may run on-demand based on changes in received power for each optical channel.

The disclosure also provides methods for monitoring the stability of an optical channel in real time and methods for recalibration as needed. The stability of the optical channel may be affected by stability of various mechanical and electrical elements of the optical channel (e.g., the transmitter, mirror control voltages, various mirrors and lenses, the waveguide face, and the receiver). For example, the locations of the various mechanical elements of the optical channel may vary due to temperature variations, aging, and vibration, among other factors. The mirror control voltages may also drift over time due to various causes. Analysis of the mirror stability or drifting may be conducted. The optical channel may include a full end-to-end path between the transmitter and receiver, i.e., including a path between the transmitter and a first MEMS micro-mirror, a path between the receiver and a second MEMS micro-mirror, and a path in the waveguide between the first and second MEMS micro-mirrors.

The methods monitor stability of received power and recalibrated to compensate for any drift in system performance. Stability of the received power may be monitored via power received by a photodetector, where the power received by the photodetector is compared to an original calibration value or a pre-defined threshold. During monitoring the stability, the optimization scan algorithm allows to continuously adjust the mirror position and to lock the mirrors into positions that have a maximum received power. The optimization scan algorithm may be invoked automatically if the power received by the photodetector falls below the pre-defined threshold. The optimization scan algorithm may be invoked manually following an electronic flag that may be set by the controller or by human intervention. The optimization scan can also be invoked periodically and automatically.

The disclosed method may increase the alignment accuracy to be substantially better than +/−0.5 microns for single mode (SM) laser or substantially better than +/−1 microns for multi-mode (MM) laser.

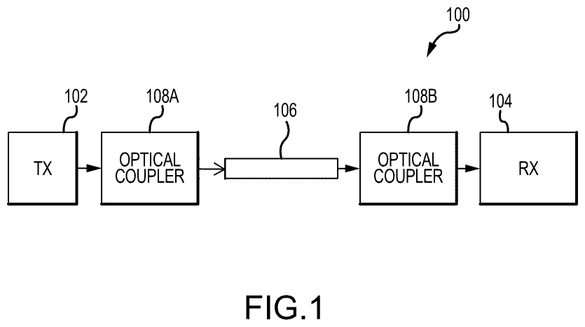

FIG. 1 illustrates a system including an optical waveguide coupled between a transmitter and a receiver in accordance with some aspects of the present technology. As shown in FIG. 1, an optical system 100 may include a transmitter (Tx) 102, a receiver (Rx) 104, and an optical waveguide 106 coupled between the receiver 104 and the transmitter 102. The transmitter and the receiver are also referred to as optical components or optical engines. The optical system 100 may also include a first optical coupler 108A between the transmitter 102 and the optical waveguide 106, and a second optical coupler 108B between the receiver 104 and the optical waveguide 106. Each of the optical couplers 108A-B may include MEMS mirrors, optical lens, light turning mirrors associated with the MEMS micro-mirror devices, among others.

The alignments among the waveguide 106, the transmitter 102, and receiver 104 affect the loss of optical power from the transmitter 102 to the receiver 104. The optical couplers 108A and 108B help with precision alignments among the waveguide 106, the transmitter 102, and receiver 104. It is desirable to have precision alignments to reduce the power loss or to have a minimum power loss.

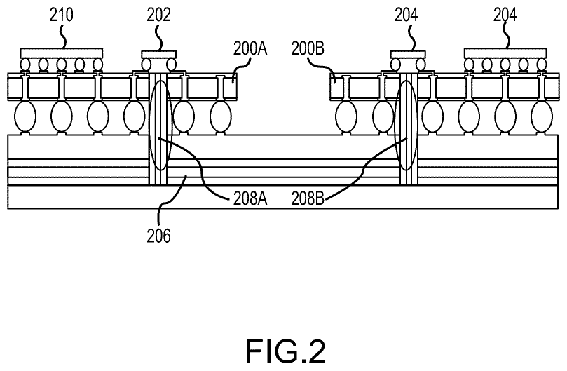

FIG. 2 illustrates an optical PCB including a PCB integrated with a waveguide via optical coupling elements in accordance with some aspects of the present technology. As shown, an optical PCB system 200 may include a transmitter module (e.g., ball grid array (BGA) transmitter) and a receiver module 200B (e.g., BGA receiver). The transmitter module 200A may include a light transmitter 202, such as VCSEL array and the transmitter module may also include a laser driver 210. The receiver module 200B may include a receiver or photodetector 204, such as a photodiode. The optical PCB system also may include a waveguide integrated with a PCB or a PCB integrated optical waveguide 206 between the light transmitter 202 (e.g., VCSEL array) and the photodetector (e.g., photodiode array) 204. The PCB integrated optical waveguide 206 may have one end coupled to the transmitter 202 via a first micro-optical coupling element (or elements) 208A, such a MEMS micro-mirror. The PCB integrated optical waveguide 206 may have another end coupled to the receiver 204 via a second micro-optical coupling element (or elements) 208B, such a MEMS micro-mirror. The coupling elements may include optical lenses and light turning mirrors associated with the MEMS micro-mirror devices, among others.

As shown in FIG. 2, separate optical engines (e.g., transmitter and receiver) may be mounted on a substrate with the ASIC. In some variations, the optical engines and ASICs may also be mounted directly on the PCB without the modules 200A or 200B. In some variations, the optical engines may also be fully integrated within the ASIC itself.

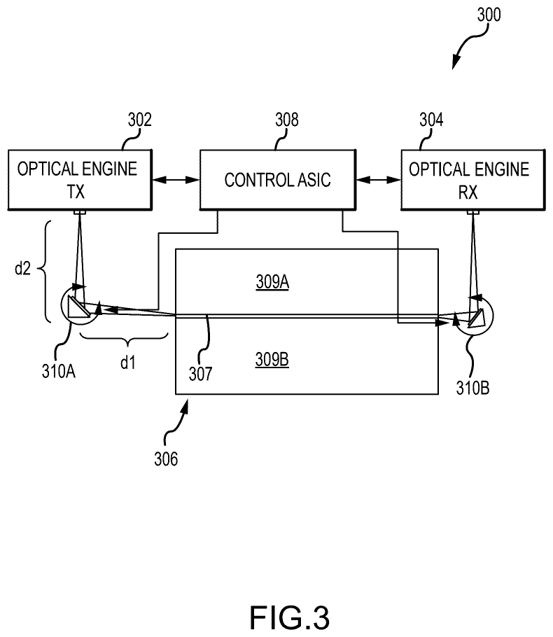

FIG. 3 illustrates an optical PCB system including 90-degree-turn MEMS micro-mirrors in accordance with some aspects of the present technology. As shown, a system 300 may include a first optical engine 302 (e.g., transmitter), a second optical engine 304 (e.g., receiver or photodetector), a waveguide 306. The system 300 may also include a controller 308, which is in electrical communication with the optical engine 302 (e.g., transmitter), and is also in electrical communication with the photodetector 304 (e.g., receiver).

The system 300 also may include at least two MEMS micro-mirrors 310A and 310B coupled to two opposite ends of the waveguide 306. In some aspects, the waveguide 306 may include a core channel 307 between a top clad layer 309A and a bottom clad layer 309B, where the light travels through the core channel 307. The top clad layer 309A or the bottom clad layer 309B may also cover the vertical edges of the core channel 307, such that the core channel 307 is completely surrounded by the top clad layer and bottom clad layer. In some aspects, the waveguide may include a core surrounded by a cladding layer. The MEMS micro-mirrors are devices used in optical systems to direct light from one position to another over a range of reflection angles. The reflection angle of a micro-mirror can be adjusted by an actuation mechanism that rotates and moves a mirror surface of the micro-mirror.

The controller 308 is in electrical communication with the at least two MEMS micro-mirrors 310A and 310B and control the dynamic movements of the two MEMS micro-mirrors 310A and 310B to obtain their optimized alignments with the waveguide 306. As an example, the mirror 310A may be positioned at a distance d1 from an entrance of the waveguide 306 and at a distance d2 from the optical engine 302.

The MEMS micro-mirrors 310A and 310B may be curved MEMS micro-mirrors, which may obviate the need for optical lenses.

A misalignment between any two components including the optical engine 302, the Tx side mirror 310A, the waveguide 306, the Rx side mirror 310B and the photodetector or receiver 304 may result in a dead channel, i.e., light from the transmitter 302 may never reach the photodetector or receiver 304. When a light beam misses the target zones of the MEMS micro-mirrors 310A and 310B, the light beam may be scattered and lost in top and bottom clad layers 309A-B of the waveguide 306. Thus, no useful power can reach the photodetector or receiver 304.

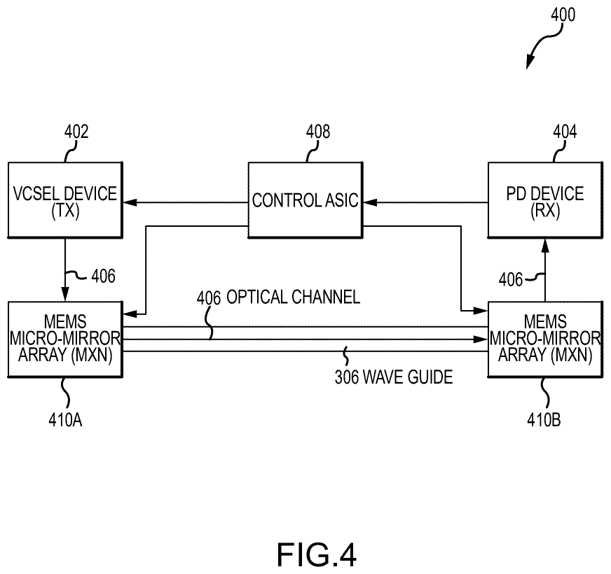

FIG. 4 illustrates a block diagram for precision alignments of an optical PCB system by dynamically adjusting MEMS micro-mirrors using a controller in accordance with some aspects of the present technology. As shown, a system 400 may include a VCSEL device 402 which is a transmitter. The system 400 also may include a photodetector device 404, which is a receiver. The system also may include a waveguide 306, which forms a portion of an optical channel 406. The system 400 also may include a first MEMS micro-mirror array 410A coupled between the transmitter 402 and one end of the waveguide 306, and a second MEMS micro-mirror array 410B coupled between the receiver 404 and another end of the waveguide 306.

The optical channel 406 may include a first path between the transmitter 402 and the first MEMS micro-mirror array 410A. The optical channel 406 may also include a second path in the waveguide 306 between the first and second MEMS micro-mirror arrays 410A and 410B. The optical channel 406 may also include a third path between the receiver 404 and the second MEMS micro-mirror array 410B.

The system 400 may include a controller 408, which may include an ASIC (application specific integrated circuit). The controller 408 may control the VCSEL to be on or off. The controller 408 may also receive the report of power, either periodically or continuously, from the photodetector device 404. The controller also controls movements or scans of MEMS arrays 410A and 410B by using an optimization scan algorithm. For example, the MEMS micro-mirror arrays 410A or 410B may be a linear or matrix array, among others. A linear micro-mirror array may include micro-mirrors that are packed together along a line or lines. For example, the MEMS micro-mirror array may be M×N, where M and N are integers. For example, when M is 1 1×N is a linear array may include N micro-mirrors. The number of micro-mirrors may vary.

The optical scans by adjusting positions of the MEMS micro-mirrors may be optimized to reduce a total scan time to achieve the optimization of the MEMS micro-mirror positions for precision alignments of the optical system. To reduce the total scan time, a scan having a large size may be broken down into two or more scans having smaller scan sizes. Each preceding scan may have a maximum power output at a particular zone. Each succeeding scan may be centered around a particular zone having the maximum power output from the preceding scan.

As one example, the scans may include a coarse scan, a medium scan, and a fine scan sequentially. The coarse scan or a first optical scan has a relatively low resolution and a large scan spot size. The coarse scan can be obtained by using a controller to control the movements of a first mirror or a first MEMS micro-mirror to a first mirror position or a first scan position, then dynamically controlling movements of a second mirror or a second MEMS micro-mirror to perform the first optical scan. The first MEMS micro-mirror may be coupled to a first optical component, e.g., a transmitter or a receiver. The second MEMS micro-mirror may be coupled to a second optical component, e.g., a receiver or a transmitter. If the receiver receives no signal, the first MEMS micro-mirror is moved to a second scan position, a third scan position, . . . until an optical signal is detected by the receiver. When the first mirror moves to the first scan position, the second mirror moves to all possible positions to scan all possible areas, e.g., performs a full-matrix scan. If no optical signal is detected, the first mirror moves to the second scan position, and the second mirror moves to scan all possible positions again. If there is still no signal detected, the first mirror moves to the third scan position and the second mirror again moves to scan all possible positions. This is repeated until the first mirror moves to a position that is identified as the maximum received power position for the first mirror based on the second mirror moving to all possible areas to scan all possible areas.

When a full scan row or a subsequent scan row shows no increase in power over the previous power was recorded in the previous scan row where the maximum power spot has been identified. Note that the power in the subsequent scan row is a total power of all scan spots in the subsequent scan roll. The previous power is a total power of all scan spots in the previous scan roll.

When the maximum power spot is identified, no further scanning is needed for that resolution (coarse, medium, fine, etc.). Scanning may be terminated to reduce scan time, and the positions of the first mirror and the second mirror are recorded for the maximum received power.

In some variations, the full-matrix scan may start from the left to the right in a first row, then from the right to the left in a second row, followed by scan from the left to the right again in a third row, and then from the right to the left again in a fourth row. Alternatively, the full-matrix scan may start from the right to the left in a first row, from the left to the right in a second row, followed by scan from the right to the left again in a third row, and then from the left to the right again in a fourth row.

In other variations, the full-matrix scan may start from the left to the right in a first row. The scan repeats for the second row, third row, and so on. Alternatively, the full-matrix scan may start from the right to the left in a first row. The scan repeats for the second row, third row, and so on.

In other variations, the full matrix scan may start in the center of the total scan area for any scan resolution, such as coarse, medium, fine, etc., and scan spiral outward from the center to edge(s) in order to further reduce total scan time.

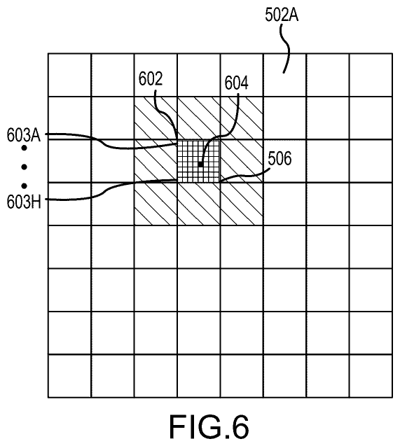

The medium scan or a second optical scan can have a finer or higher resolution than the coarse scan. The medium scan has a smaller scan size than the coarse scan. The medium scan be performed within the zone, identified in the previous resolution scan, having the maximum received power. For example, the maximum power scan spot 506 may be the zone identified in the coarse scan as illustrated in FIG. 6.

The fine scan or a third optical scan can have a finer or higher resolution than the medium scan. The fine scan has a smaller scan size than the medium scan. The fine scan be performed within the zone, identified in the previous resolution scan, having the maximum received power. By using the above method, a total scanning time is significantly reduced. For example, the maximum power scan spot 604 may be the zone identified in the medium scan as illustrated in FIG. 6.

For example, for a scan area covered by 10 rows and 10 columns, the medium scan is focused on or centered on only 1/100 of the selected area from the coarse scan or the second optical scan. This reduces the scanning time to 1/100 compared to the conventional approach.

Similarly, the fine scan or third optical scan is focused on only 1/100 of the selected area from the medium scan or the third optical scan. This further reduces the scanning time to 1/10,000.

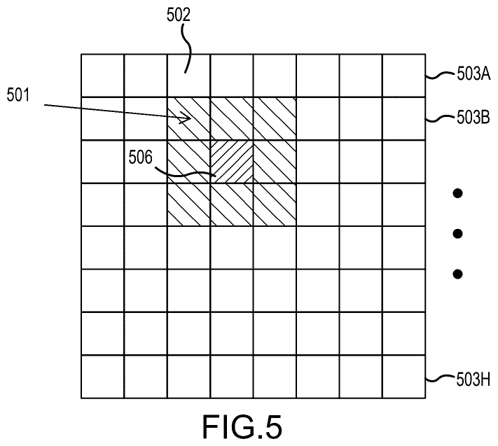

As another example, the scans may include a coarse scan as illustrated in FIG. 5 and a fine scan illustrated in FIG. 6.

FIG. 5 illustrates a coarse scan for optimizing positions of a first and a second MEMS micro-mirrors of an optical PCB system in accordance with some aspects of the present technology. As shown in FIG. 5, a coarse scan is a full-matrix scan covering a plurality of rows, e.g., rows 503A-503H. Each row includes a plurality of scan areas or spots 502 having a relatively large scan size or relatively low resolution. When a first MEMS micro-mirror moves to a first mirror position, the second MEMS micro-mirror moves to obtain a coarse scan of the entire area including 8 rows 503A-503H. For example, the first MEMS micro-mirror may have a number of positions, e.g., 64 positions. The first mirror position is one of the 64 positions corresponding to 64 scan spots. For example, the first mirror position corresponds to a first left spot 502 on the top row. The coarse scan is a full-matrix scan, which may start from a left end of a first row 503A on a top to a right end of the first row 503A, then the scan may start from a left end of a second row 503B to a right end of the second row 503B, then the scan may continue to the 8th row 503H at a bottom to complete. It will be appreciated by those skilled in the art that the number of rows and columns may vary in the coarse scan.

If the receiver receives no power, the first MEMS micro-mirror moves to a second mirror position, the second MEMS micro-mirror moves to obtain a second full-matrix coarse scan. If the receiver receives no power, the first MEMS micro-mirror moves to a third mirror position, the second MEMS micro-mirror moves to obtain a third full-matrix coarse scan.

The above process repeats until a maximum power signal is detected by the receiver or photodetector, for example, the first MEMS micro-mirror and the second MEMS micro-mirror are positioned to generate optical signals within a scan region 501, within the scan region 501 a maximum power spot is identified. The full-matrix scan may be terminated early to reduce scan time as soon as the maximum power signal is identified. Outside the scan region 501, there is no optical signal. The scan region 501 may include an area of multiple squares (e.g., 9 squares) around a center scan spot 506 having a maximum power received by the receiver. It will be appreciated by those skilled in the art that the number of squares may vary in the scan region 501. The spot 506 may not be in the center of the scan region 501. Each square corresponds to a respective position of the first mirror and a respective position of the second mirror.

In FIG. 5, when the scan on the 5^{th} row (e.g., row 503E), the scan shows no increase in the total power over the 4^{th} row (e.g., row 503D) including the maximum power scan spot 506, the scan can be terminated, which would save the scan time for the rows below including 6^{th} row till the 8^{th} row.

The power received by the photodetector 304 or 404 may be stored in a memory device, e.g., ASIC memory device, for each of the possible locations, the locations of the MEMS micro-mirrors having the maximum power output may be selected as starting positions for a subsequent fine scan. Then, the mirrors may be locked at the positions or zones having the maximum power output among the scans.

In some aspects, a full-matrix scan may cover a two-dimensional area including a first plurality of rows 503A-503H. Each of the first plurality of rows may include a first plurality of scan spots 502 or scan areas having the first scan size corresponding to a first plurality of channels of the photodetector.

FIG. 6 illustrates a fine scan for optimizing positions of the first and second MEMS micro-mirrors of the optical PCB system in accordance with some aspects of the present technology. The coarse scan shown in FIG. 5 is a preceding scan of the fine scan shown in FIG. 6, which is a succeeding scan of the coarse scan. As shown in FIG. 6, a fine scan is a full-matrix scan covering the first maximum power spot 506, which has been selected among many scan areas or spots 502 to have the first maximum power during the coarse scan. The fine scan has a finer resolution than the coarse scan. In other words, a small scan spot 602 may have a smaller square area, which is a fraction of the large scan size. For example, the fraction may be 1/64 of the large scan spot 502. It will be appreciated by those skilled in the art that the fraction may vary.

During the fine scan, a second maximum power spot 604 may be identified to have a second maximum power during the fine scan. The second maximum power spot 604 is obtained when the first MEMS micro-mirror moves to a second maximum power position and the second MEMS micro-mirror moves to a second mirror zone. The second maximum power position and the second mirror zone are selected to be an optimized position or mirror zone for the first MEMS micro-mirror and the second MEMS micro-mirror. At the second maximum power spot or area 604, the receiver detects the maximum power among all the scan areas 602 within the first maximum power spot or area 506. The position of the first MEMS micro-mirror may be locked in the second maximum power position. The position of the second MEMS micro-mirror may be locked in a center of the optimized position zone or second mirror zone. The optimization process may continue to have a further finer scan with a smaller scan spot than the small scan spot 602.

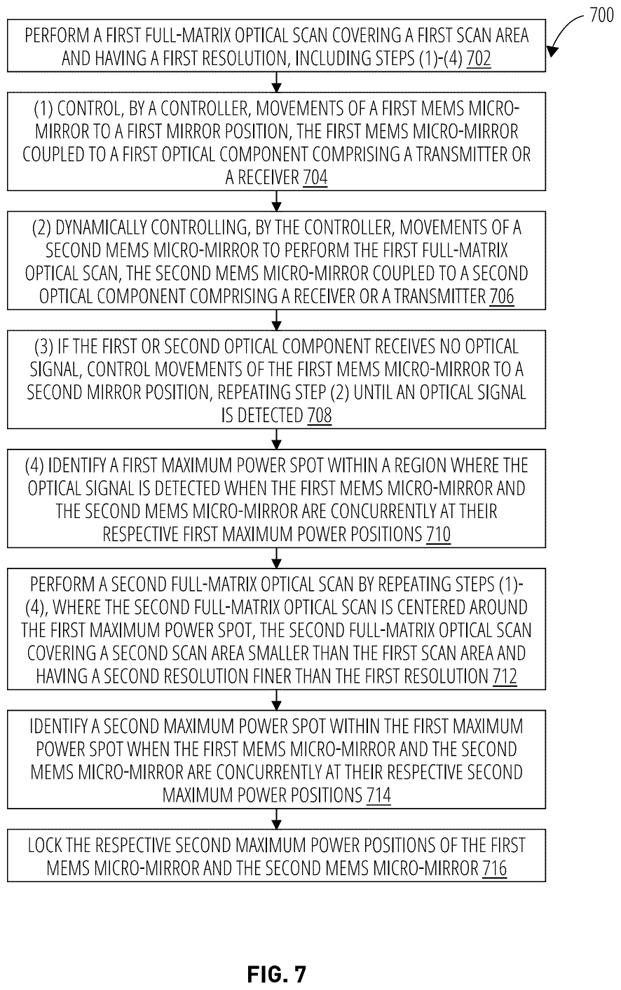

FIG. 7 illustrates a flow chart illustrating the steps for automatic alignment of a system including a first optical component, a second optical component, a waveguide, and one or more micro-electromechanical system (MEMS) mirrors. The optimization scan algorithm may use the method including the steps in the flow chart.

At operation 702, method 700 may include performing a first full-matrix optical scan covering a first scan area and having a first resolution, including steps (1)-(4). For example, the controller 308 or 408 may use an optimization scan algorithm to control performing a first full-matrix optical scan covering a first scan area and having a first resolution, including steps (1)-(4).

At operation 704, step (1) may include controlling, by the controller, movements of a first MEMS micro-mirror to a first mirror position, the first MEMS micro-mirror coupled to a first optical component comprising a transmitter or a receiver.

At operation 706, step (2) may include dynamically controlling, by the controller, movements of a second MEMS micro-mirror to perform the first full-matrix optical scan, the second MEMS micro-mirror coupled to a second optical component comprising a receiver or a transmitter.

At operation 708, step (3) may include: if the first or second optical component receives no optical signal, the algorithm may control movements of the first MEMS micro-mirror to a second mirror position, repeating step (2) until an optical signal is detected.

At operation 710, step (4) may include identifying a first maximum power spot within a region where the optical signal is detected when the first MEMS micro-mirror and the second MEMS micro-mirror are concurrently at their respective first maximum power positions. For example, the algorithm may identify a first maximum power spot within a region where the optical signal is detected when the first MEMS micro-mirror and the second MEMS micro-mirror are concurrently at their respective first maximum power positions

At operation 712, method 700 may also include performing a second full-matrix optical scan by repeating steps (1)-(4), where the second full-matrix optical scan is centered around the first maximum power spot, the second full-matrix optical scan covering a second scan area smaller than the first scan area and having a second resolution finer than the first resolution. For example, the controller 308 or 408 may use an optimization scan algorithm to control performing a second full-matrix optical scan covering a first scan area and having a first resolution, including steps (1)-(4), which are operations 704, 706, 708, and 710.

At operation 714, method 700 may also include identifying a second maximum power spot within the first maximum power spot when the first MEMS micro-mirror and the second MEMS micro-mirror are concurrently at their respective second maximum power positions. For example, the controller 308 or 408 may use an optimization scan algorithm to identify a second maximum power spot within the first maximum power spot when the first MEMS micro-mirror and the second MEMS micro-mirror are concurrently at their respective second maximum power positions.

At operation 716, method 700 may further include locking the respective second maximum power positions of the first MEMS micro-mirror and the second MEMS micro-mirror. For example, the controller 308 or 408 may use an optimization scan algorithm to control locking the respective second maximum power positions of the first MEMS micro-mirror and the second MEMS micro-mirror.

In some aspects, method 700 may also include performing a third full-matrix optical scan by repeating steps (1)-(4), wherein the third full-matrix optical scan is centered around the second maximum power spot corresponding to a second maximum power received by one of the optical components, the third full-matrix optical scan having a third resolution finer than the second resolution; identifying a third maximum power spot when the first MEMS micro-mirror and the second MEMS micro-mirror are concurrently at their respective third maximum power positions; and locking the respective third maximum power positions of the first MEMS micro-mirror and the second MEMS micro-mirror.

In some aspects, method 700 may also include monitoring stability of an optical channel 406 by continuously evaluating power received from the first optical component 302, 402 or 304, 404 or second optical component 302 or 402 or 304, 404. Each of the first optical component and the second optical component may be a photodetector or receiver, or a transmitter. The optical channel may include a first path between either the first optical component or the second optical component and the first MEMS micro-mirror, and a second path between the first MEMS micro-mirror and the waveguide.

In some aspects, monitoring stability of an optical channel 406 by continuously evaluating power received from one of the first or second optical component may include periodically comparing a second maximum power received by one of the first or second optical component and corresponding to the second maximum power spot with a pre-defined threshold to determine if the second maximum power is below the pre-defined threshold; performing a fourth full-matrix optical scan by repeating steps (1)-(4), or operations 704, 706, 708, and 710, wherein the fourth full-matrix optical scan is centered around the second maximum power spot generating the second maximum power from the second full-matrix optical scan; identifying a fourth maximum power spot when the first MEMS micro-mirror and the second MEMS micro-mirror are concurrently at their respective fourth maximum power positions; and locking the respective fourth maximum power positions of the first MEMS micro-mirror and the second MEMS micro-mirror.

In some aspects, method 700 may also include detecting optical signals, by the first or second optical component for the first full-matrix optical scan and detecting optical signals, by the first or second optical component for the second full-matrix optical scan.

In some aspects, identifying the first maximum power spot may include comparing a second power received in a subsequent scan row with a first power received in a previous scan row, wherein the first power is a total power of all scan spots in the previous scan row, and the second power is a total power of all scan spots in the subsequent scan row; and terminating a full-matrix optical scan if the second power reveals no increase.

In some aspects, the first full-matrix optical scan may cover a first two-dimensional area including a first plurality of rows, each of the first plurality of rows including a first plurality of scan spots based on the first resolution.

In some aspects, the second full-matrix optical scan may cover a second two-dimensional area including a second plurality of rows, each of the second plurality of rows including a second plurality of scan spots based on the second resolution.

In some aspects, the system may be an optical PCB system 300 or 400 including a waveguide in a printed circuit board (PCB) and a second MEMS micro-mirror 310B or 410B, where the first MEMS micro-mirror 310A or 410A is positioned near an entrance of the waveguide 306 and configured to direct lights from a transmitter toward the waveguide, and the second MEMS micro-mirror 310B or 410B is positioned at an exit of the waveguide 306 and configured to direct lights toward the photodetector.

In some aspects, the MEMS micro-mirrors may be configured to change a direction of light about 90°.

In some aspects, the waveguide 306 may include a core channel 307 between a first clad layer 309A and a second clad layer 309B, where the light travels through the core channel.

In some aspects, the transmitter may include a VCSEL or any other type of light source emitting light downwards to optical PCB.

In some aspects, the system 300 or 400 may have an accuracy of alignments within +/−0.5 μm for a single mode laser.

In some aspects, the system 300 or 400 may have an accuracy of alignments within +/−1 μm for a multi-mode mode laser.

In some aspects, the method 700 may also include storing the power output corresponding to the second scan area 604 that generates the second maximum power.

In some aspects, the method 700 may also include continuously receiving, by the controller 308 or 408, power output from the photodetector 304 or 404.

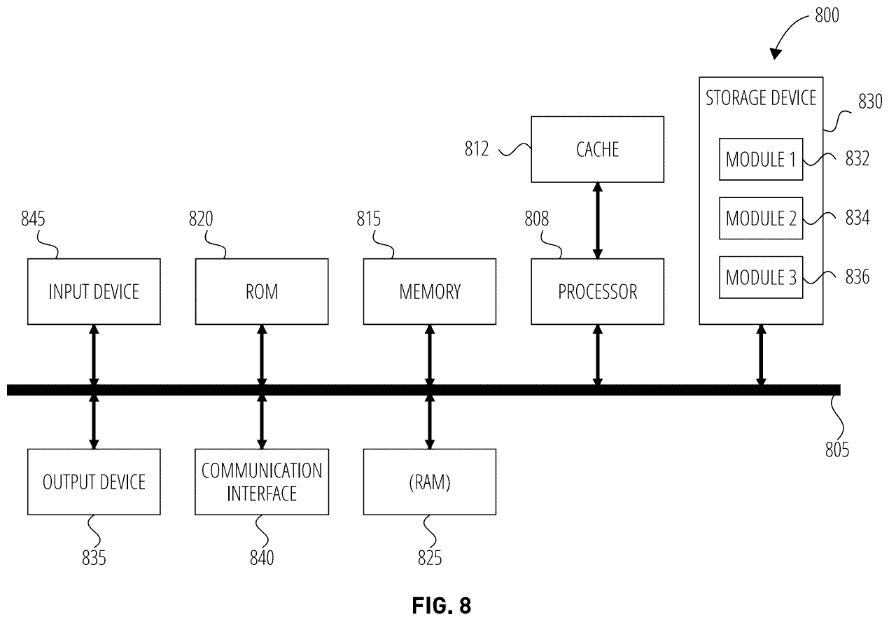

FIG. 8 shows an example of computing system 800, which can be, controller 308 or 408, or any computing device or any component thereof in which the components of the system are in communication with each other using connection 805. Connection 805 can be a physical connection via a bus, or a direct connection to processor 808, such as in a chipset architecture. Connection 805 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 800 may include at least one processing unit (CPU or processor) 508 and connection 805 that couples various system components including memory 815, such as read-only memory (ROM) 820 and random-access memory (RAM) 825 to processor 808. Computing system 800 can include a cache of high-speed memory 812 connected directly with, in close proximity to, or integrated as part of processor 808.

Processor 808 can include any general-purpose processor and a hardware service or software service, such as services 832, 834, and 836 stored in storage device 830, configured to control processor 808 as well as a special-purpose processor where software instructions are incorporated into the actual processor design. Processor 808 may essentially be a completely self-contained computing system, containing multiple cores or processors, a bus, memory controller, cache, etc. A multi-core processor may be symmetric or asymmetric.

To enable user interaction, computing system 800 may include an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. There is no restriction on operating on any particular hardware arrangement, and therefore the basic features here may easily be substituted for improved hardware or firmware arrangements as they are developed.

Storage device 830 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 830 can include software services, servers, services, etc., that when the code that defines such software is executed by the processor 808, it causes the system to perform a function. In some embodiments, a hardware service that performs a particular function can include the software component stored in a computer-readable medium in connection with the necessary hardware components, such as processor 808, connection 805, output device 835, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Clause 1. A method for automatic alignment of a system including a first optical component, a second optical component, a waveguide, and one or more micro-electromechanical system (MEMS) mirrors, the method comprising: performing a first full-matrix optical scan covering a first scan area and having a first resolution, including steps (1)-(4), (1) controlling, by a controller, movements of a first MEMS micro-mirror to a first mirror position, the first MEMS micro-mirror coupled to a first optical component comprising a transmitter or a receiver, (2) dynamically controlling, by the controller, movements of a second MEMS micro-mirror to perform the first full-matrix optical scan, the second MEMS micro-mirror coupled to a second optical component comprising a receiver or a transmitter, (3) if the first or second optical component receives no optical signal, controlling movements of the first MEMS micro-mirror to a second mirror position, repeating step (2) until an optical signal is detected, (4) identifying a first maximum power spot within a region where the optical signal is detected when the first MEMS micro-mirror and the second MEMS micro-mirror are concurrently at their respective first maximum power positions; performing a second full-matrix optical scan by repeating steps (1)-(4), where the second full-matrix optical scan is centered around the first maximum power spot, the second full-matrix optical scan covering a second scan area smaller than the first scan area and having a second resolution finer than the first resolution; identifying a second maximum power spot within the first maximum power spot when the first MEMS micro-mirror and the second MEMS micro-mirror are concurrently at their respective second maximum power positions; and locking the respective second maximum power positions of the first MEMS micro-mirror and the second MEMS micro-mirror.

Clause 2. The method of clause 1, further comprising: performing a third full-matrix optical scan by repeating steps (1)-(4), wherein the third full-matrix optical scan is centered around the second maximum power spot corresponding to a second maximum power received by one of the optical components, the third full-matrix optical scan having a third resolution finer than the second resolution; identifying a third maximum power spot when the first MEMS micro-mirror and the second MEMS micro-mirror are concurrently at their respective third maximum power positions; and locking the respective third maximum power positions of the first MEMS micro-mirror and the second MEMS micro-mirror.

Clause 3. The method of clause 1, further comprising: monitoring stability of an optical channel by continuously evaluating power received from the first or second optical component, wherein the optical channel comprises a first path between either the first optical component or the second optical component and the first MEMS micro-mirror, and a second path between the first MEMS micro-mirror and the waveguide.

Clause 4. The method of clause 3, wherein the monitoring stability of an optical channel by continuously evaluating power received from one of the first or second optical component comprises: periodically comparing a second maximum power received by one of the first or second optical component and corresponding to the second maximum power spot with a pre-defined threshold to determine if the second maximum power is below the pre-defined threshold; performing a fourth full-matrix optical scan by repeating steps (1)-(4), wherein the fourth full-matrix optical scan is centered around the second maximum power spot generating the second maximum power from the second full-matrix optical scan; identifying a fourth maximum power spot when the first MEMS micro-mirror and the second MEMS micro-mirror are concurrently at their respective fourth maximum power positions; and locking the respective fourth maximum power positions of the first MEMS micro-mirror and the second MEMS micro-mirror.

Clause 5. The method of clause 1, further comprising: detecting optical signals, by the first or second optical component for the first full-matrix optical scan; and detecting optical signals, by the first or second optical component for the second full-matrix optical scan.

Clause 6. The method of clause 1, further comprising continuously receiving, by the controller, power outputs from the first or second optical component.

Clause 7. The method of clause 1, wherein the system is an optical PCB system comprising a waveguide in a printed circuit board (PCB) and a second MEMS micro-mirror, wherein the first MEMS micro-mirror is positioned near an entrance of the waveguide and configured to direct optical signals from a transmitter toward the waveguide, and the second MEMS micro-mirror is positioned at an exit of the waveguide and configured to direct the optical signals toward a photodetector or receiver.

Clause 8. The method of clause 7, wherein the waveguide comprises a core channel between a first clad layer and a second clay layer, wherein lights travel through the core channel.

Clause 9. The method of clause 7, wherein the transmitter comprises one of a vertical cavity surface emitter laser (VCSEL), light-emitting diode (LED), or edge emitting laser (EEL).

Clause 10. The method of clause 7, wherein the system has an accuracy of alignments within +/−0.5 μm for a single mode laser.

Clause 11. The method of clause 7, wherein the system has an accuracy of alignments within +/−1 μm for a multi-mode mode laser.

Clause 12. The method of clause 1, wherein the first MEMS micro-mirror is configured to change a direction of light about 90°.

Clause 13. The method of clause 1, wherein the identifying the first maximum power spot comprises: comparing a second power received in a subsequent scan row with a first power received in a previous scan row, wherein the first power is a total power of all scan spots in the previous scan row, and the second power is a total power of all scan spots in the subsequent scan row; and terminating a full-matrix optical scan if the second power reveals no increase.

Clause 14. The method of clause 1, wherein the first full-matrix optical scan covers a first two-dimensional area including a first plurality of rows, each of the first plurality of rows comprising a first plurality of scan spots based on the first resolution.

Clause 15. The method of clause 14, wherein the second full-matrix optical scan covers a second two-dimensional area including a second plurality of rows, each of the second plurality of rows comprising a second plurality of scan spots based on the second resolution.

Clause 16. A non-transitory computer-readable storage medium for automatic alignment of a system including a transmitter, a photodetector, a waveguide, and one or more micro-electromechanical system (MEMS) mirrors, the non-transitory computer-readable storage medium including instructions that when executed by a computer, cause the computer to: perform a first full-matrix optical scan covering a first scan area and having a first resolution, including steps (1)-(4), (1) controlling, by a controller, movements of a first MEMS micro-mirror to a first mirror position, the first MEMS micro-mirror coupled to a first optical component comprising a transmitter or a receiver, (2) dynamically controlling, by the controller, movements of a second MEMS micro-mirror to perform the first full-matrix optical scan, the second MEMS micro-mirror coupled to a second optical component comprising a receiver or a transmitter, (3) if the first or second optical component receives no optical signal, controlling movements of the first MEMS micro-mirror to a second mirror position, repeating step (2) until an optical signal is detected, (4) identifying a first maximum power spot within a region where the optical signal is detected when the first MEMS micro-mirror and the second MEMS micro-mirror are concurrently at their respective first maximum power positions; perform a second full-matrix optical scan by repeating steps (1)-(4), where the second full-matrix optical scan is centered around the first maximum power spot, the second full-matrix optical scan covering a second scan area smaller than the first scan area and having a second resolution finer than the first resolution; identify a second maximum power spot within the first maximum power spot when the first MEMS micro-mirror and the second MEMS micro-mirror are concurrently at their respective second maximum power positions; and lock the respective second maximum power positions of the first MEMS micro-mirror and the second MEMS micro-mirror.

Clause 17. The non-transitory computer-readable storage medium of clause 16, wherein the instructions to monitor stability of an optical channel by continuously evaluating power received from one of the first or second optical component comprise instructions that further configure the computer to: perform a third full-matrix optical scan by repeating steps (1)-(4), wherein the third full-matrix optical scan is centered around the second maximum power spot corresponding to a second maximum power received by one of the optical components, the third full-matrix optical scan having a third resolution finer than the second resolution; identify a third maximum power spot when the first MEMS micro-mirror and the second MEMS micro-mirror are concurrently at their respective third maximum power positions; and lock the respective third maximum power positions of the first MEMS micro-mirror and the second MEMS micro-mirror.

Clause 18. The non-transitory computer-readable storage medium of clause 16, wherein the instructions further configure the computer to: monitor stability of an optical channel by continuously evaluating power received from the first or second optical component, wherein the optical channel comprises a first path between either the first optical component or the second optical component and the first MEMS micro-mirror, and a second path between the first MEMS micro-mirror and the waveguide.

Clause 19. The non-transitory computer-readable storage medium of clause 18, wherein the instructions to monitor stability of an optical channel by continuously evaluating power received from one of the first or second optical component further comprise instructions that configure the computer to: periodically compare a second maximum power received by one of the first or second optical component and corresponding to the second maximum power spot with a pre-defined threshold to determine if the second maximum power is below the pre-defined threshold; perform a fourth full-matrix optical scan by repeating steps (1)-(4), wherein the fourth full-matrix optical scan is centered around the second maximum power spot generating the second maximum power from the second full-matrix optical scan; identify a fourth maximum power spot when the first MEMS micro-mirror and the second MEMS micro-mirror are concurrently at their respective fourth maximum power positions; and lock the respective fourth maximum power positions of the first MEMS micro-mirror and the second MEMS micro-mirror.

Clause 20. The non-transitory computer-readable storage medium of clause 16, wherein the instructions further configure the computer to: detect optical signals, by the first or second optical component for the first full-matrix optical scan; and detect optical signals, by the first or second optical component for the second full-matrix optical scan.

Clause 21. The non-transitory computer-readable storage medium of clause 16, wherein the instructions to identify the first maximum power spot further comprise the instructions that configure the computer to: compare a second power received in a subsequent scan row with a first power received in a previous scan row, wherein the first power is a total power of all scan spots in the previous scan row, and the second power is a total power of all scan spots in the subsequent scan row; and terminate a full-matrix optical scan if the second power reveals no increase.

Clause 22. The non-transitory computer-readable storage medium of clause 16, wherein the instructions further configure the computer to continuously receive, by the controller, power outputs from the first or second optical component.

Clause 23. The non-transitory computer-readable storage medium of clause 16, wherein the system is an optical PCB system comprising a waveguide in a printed circuit board (PCB) and a second MEMS micro-mirror, wherein the first MEMS micro-mirror is positioned near an entrance of the waveguide and configured to direct optical signals from a transmitter toward the waveguide, and the second MEMS micro-mirror is positioned at an exit of the waveguide and configured to direct the optical signals toward a photodetector or receiver.

Clause 24. The non-transitory computer-readable storage medium of clause 16, wherein the waveguide comprises a core channel between a first clad layer and a second clay layer, wherein lights travel through the core channel.

Clause 25. The non-transitory computer-readable storage medium of clause 16, wherein the transmitter comprises one of a vertical cavity surface emitter laser (VCSEL), light-emitting diode (LED), or edge emitting laser (EEL).

Clause 26. The non-transitory computer-readable storage medium of clause 16, wherein the system has an accuracy of alignments within +/−0.5 μm for a single mode laser.

Clause 27. The non-transitory computer-readable storage medium of clause 16, wherein the system has an accuracy of alignments within +/−1 μm for a multi-mode mode laser.

Clause 28. The non-transitory computer-readable storage medium of clause 16, wherein the first MEMS micro-mirror is configured to change a direction of light about 90°.

Clause 29. The non-transitory computer-readable storage medium of clause 16, wherein the first full-matrix optical scan covers a first two-dimensional area including a first plurality of rows, each of the first plurality of rows comprising a first plurality of scan spots based on the first resolution.

Clause 30. The non-transitory computer-readable storage medium of clause 16, wherein the second full-matrix optical scan covers a second two-dimensional area including a second plurality of rows, each of the second plurality of rows comprising a second plurality of scan spots based on the second resolution.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method for automatic alignment of a system including a first optical component, a second optical component, a waveguide, and one or more micro-electromechanical system (MEMS) mirrors, the method comprising:
performing a first full-matrix optical scan covering a first scan area and having a first resolution, including steps (1)-(4),
(1) controlling, by a controller, movements of a first MEMS micro-mirror to a first mirror position, the first MEMS micro-mirror coupled to a first optical component comprising a transmitter or a receiver,
(2) dynamically controlling, by the controller, movements of a second MEMS micro-mirror to perform the first full-matrix optical scan, the second MEMS micro-mirror coupled to a second optical component comprising a receiver or a transmitter,
(3) if the first or second optical component receives no optical signal, controlling movements of the first MEMS micro-mirror to a second mirror position, repeating step (2) until an optical signal is detected,
(4) identifying a first maximum power spot within a region where the optical signal is detected when the first MEMS micro-mirror and the second MEMS micro-mirror are concurrently at their respective first maximum power positions;
performing a second full-matrix optical scan by repeating steps (1)-(4), where the second full-matrix optical scan is centered around the first maximum power spot, the second full-matrix optical scan covering a second scan area smaller than the first scan area and having a second resolution finer than the first resolution;
identifying a second maximum power spot within the first maximum power spot when the first MEMS micro-mirror and the second MEMS micro-mirror are concurrently at their respective second maximum power positions; and
locking the respective second maximum power positions of the first MEMS micro-mirror and the second MEMS micro-mirror.

2. The method of claim 1, further comprising:
performing a third full-matrix optical scan by repeating steps (1)-(4), wherein the third full-matrix optical scan is centered around the second maximum power spot corresponding to a second maximum power received by one of the optical components, the third full-matrix optical scan having a third resolution finer than the second resolution;
identifying a third maximum power spot when the first MEMS micro-mirror and the second MEMS micro-mirror are concurrently at their respective third maximum power positions; and
locking the respective third maximum power positions of the first MEMS micro-mirror and the second MEMS micro-mirror.

3. The method of claim 1, further comprising:
monitoring stability of an optical channel by continuously evaluating power received from the first or second optical component, wherein the optical channel comprises a first path between either the first optical component or the second optical component and the first MEMS micro-mirror, and a second path between the first MEMS micro-mirror and the waveguide.

4. The method of claim 3, wherein the monitoring stability of an optical channel by continuously evaluating power received from one of the first or second optical component comprises:
periodically comparing a second maximum power received by one of the first or second optical component and corresponding to the second maximum power spot with a pre-defined threshold to determine if the second maximum power is below the pre-defined threshold;
performing a fourth full-matrix optical scan by repeating steps (1)-(4), wherein the fourth full-matrix optical scan is centered around the second maximum power spot generating the second maximum power from the second full-matrix optical scan;
identifying a fourth maximum power spot when the first MEMS micro-mirror and the second MEMS micro-mirror are concurrently at their respective fourth maximum power positions; and
locking the respective fourth maximum power positions of the first MEMS micro-mirror and the second MEMS micro-mirror.

5. The method of claim 1, further comprising:
detecting optical signals, by the first or second optical component for the first full-matrix optical scan; and
detecting optical signals, by the first or second optical component for the second full-matrix optical scan.

6. The method of claim 1, further comprising continuously receiving, by the controller, power outputs from the first or second optical component.

7. The method of claim 1, wherein the system is an optical PCB system comprising a waveguide in a printed circuit board (PCB) and a second MEMS micro-mirror, wherein the first MEMS micro-mirror is positioned near an entrance of the waveguide and configured to direct optical signals from a transmitter toward the waveguide, and the second MEMS micro-mirror is positioned at an exit of the waveguide and configured to direct the optical signals toward a photodetector or receiver.

8. The method of claim 7, wherein the waveguide comprises a core channel between a first clad layer and a second clay layer, wherein lights travel through the core channel.

9. The method of claim 7, wherein the transmitter comprises one of a vertical cavity surface emitter laser (VCSEL), light-emitting diode (LED), or edge emitting laser (EEL).

10. The method of claim 7, wherein the system has an accuracy of alignments within +/−0.5 μm for a single mode laser.

11. The method of claim 7, wherein the system has an accuracy of alignments within +/−1 μm for a multi-mode mode laser.

12. The method of claim 1, wherein the first MEMS micro-mirror is configured to change a direction of light about 90°.

13. The method of claim 1, wherein the identifying the first maximum power spot comprises:
comparing a second power received in a subsequent scan row with a first power received in a previous scan row, wherein the first power is a total power of all scan spots in the previous scan row, and the second power is a total power of all scan spots in the subsequent scan row; and
terminating a full-matrix optical scan if the second power reveals no increase.

14. The method of claim 1, wherein the first full-matrix optical scan covers a first two-dimensional area including a first plurality of rows, each of the first plurality of rows comprising a first plurality of scan spots based on the first resolution.

15. The method of claim 14, wherein the second full-matrix optical scan covers a second two-dimensional area including a second plurality of rows, each of the second plurality of rows comprising a second plurality of scan spots based on the second resolution.

16. A non-transitory computer-readable storage medium for automatic alignment of a system including a transmitter, a photodetector, a waveguide, and one or more micro-electromechanical system (MEMS) mirrors, the non-transitory computer-readable storage medium including instructions that when executed by a computer, cause the computer to:
perform a first full-matrix optical scan covering a first scan area and having a first resolution, including steps (1)-(4),
(1) controlling, by a controller, movements of a first MEMS micro-mirror to a first mirror position, the first MEMS micro-mirror coupled to a first optical component comprising a transmitter or a receiver,
(2) dynamically controlling, by the controller, movements of a second MEMS micro-mirror to perform the first full-matrix optical scan, the second MEMS micro-mirror coupled to a second optical component comprising a receiver or a transmitter,
(3) if the first or second optical component receives no optical signal, controlling movements of the first MEMS micro-mirror to a second mirror position, repeating step (2) until an optical signal is detected,
(4) identifying a first maximum power spot within a region where the optical signal is detected when the first MEMS micro-mirror and the second MEMS micro-mirror are concurrently at their respective first maximum power positions;
perform a second full-matrix optical scan by repeating steps (1)-(4), where the second full-matrix optical scan is centered around the first maximum power spot, the second full-matrix optical scan covering a second scan area smaller than the first scan area and having a second resolution finer than the first resolution;
identify a second maximum power spot within the first maximum power spot when the first MEMS micro-mirror and the second MEMS micro-mirror are concurrently at their respective second maximum power positions; and
lock the respective second maximum power positions of the first MEMS micro-mirror and the second MEMS micro-mirror.

17. The non-transitory computer-readable storage medium of claim 16, wherein the instructions to monitor stability of an optical channel by continuously evaluating power received from one of the first or second optical component comprise instructions that further configure the computer to:
perform a third full-matrix optical scan by repeating steps (1)-(4), wherein the third full-matrix optical scan is centered around the second maximum power spot corresponding to a second maximum power received by one of the optical components, the third full-matrix optical scan having a third resolution finer than the second resolution;
identify a third maximum power spot when the first MEMS micro-mirror and the second MEMS micro-mirror are concurrently at their respective third maximum power positions; and
lock the respective third maximum power positions of the first MEMS micro-mirror and the second MEMS micro-mirror.

18. The non-transitory computer-readable storage medium of claim 16, wherein the instructions further configure the computer to:
monitor stability of an optical channel by continuously evaluating power received from the first or second optical component, wherein the optical channel comprises a first path between either the first optical component or the second optical component and the first MEMS micro-mirror, and a second path between the first MEMS micro-mirror and the waveguide.

19. The non-transitory computer-readable storage medium of claim 18, wherein the instructions to monitor stability of an optical channel by continuously evaluating power received from one of the first or second optical component further comprise instructions that configure the computer to:
periodically compare a second maximum power received by one of the first or second optical component and corresponding to the second maximum power spot with a pre-defined threshold to determine if the second maximum power is below the pre-defined threshold;
perform a fourth full-matrix optical scan by repeating steps (1)-(4), wherein the fourth full-matrix optical scan is centered around the second maximum power spot generating the second maximum power from the second full-matrix optical scan;
identify a fourth maximum power spot when the first MEMS micro-mirror and the second MEMS micro-mirror are concurrently at their respective fourth maximum power positions; and
lock the respective fourth maximum power positions of the first MEMS micro-mirror and the second MEMS micro-mirror.

20. The non-transitory computer-readable storage medium of claim 16, wherein the instructions further configure the computer to:
detect optical signals, by the first or second optical component for the first full-matrix optical scan; and
detect optical signals, by the first or second optical component for the second full-matrix optical scan.

21. The non-transitory computer-readable storage medium of claim 16, wherein the instructions to identify the first maximum power spot further comprise the instructions that configure the computer to:
compare a second power received in a subsequent scan row with a first power received in a previous scan row, wherein the first power is a total power of all scan spots in the previous scan row, and the second power is a total power of all scan spots in the subsequent scan row; and
terminate a full-matrix optical scan if the second power reveals no increase.

22. The non-transitory computer-readable storage medium of claim 16, wherein the instructions further configure the computer to continuously receive, by the controller, power outputs from the first or second optical component.

23. The non-transitory computer-readable storage medium of claim 16, wherein the system is an optical PCB system comprising a waveguide in a printed circuit board (PCB) and a second MEMS micro-mirror, wherein the first MEMS micro-mirror is positioned near an entrance of the waveguide and configured to direct optical signals from a transmitter toward the waveguide, and the second MEMS micro-mirror is positioned at an exit of the waveguide and configured to direct the optical signals toward a photodetector or receiver.

24. The non-transitory computer-readable storage medium of claim 16, wherein the waveguide comprises a core channel between a first clad layer and a second clay layer, wherein lights travel through the core channel.

25. The non-transitory computer-readable storage medium of claim 16, wherein the transmitter comprises one of a vertical cavity surface emitter laser (VCSEL), light-emitting diode (LED), or edge emitting laser (EEL).

26. The non-transitory computer-readable storage medium of claim 16, wherein the system has an accuracy of alignments within +/−0.5 μm for a single mode laser.

27. The non-transitory computer-readable storage medium of claim 16, wherein the system has an accuracy of alignments within +/−1 μm for a multi-mode mode laser.

28. The non-transitory computer-readable storage medium of claim 16, wherein the first MEMS micro-mirror is configured to change a direction of light about 90°.

29. The non-transitory computer-readable storage medium of claim 16, wherein the first full-matrix optical scan covers a first two-dimensional area including a first plurality of rows, each of the first plurality of rows comprising a first plurality of scan spots based on the first resolution.

30. The non-transitory computer-readable storage medium of claim 16, wherein the second full-matrix optical scan covers a second two-dimensional area including a second plurality of rows, each of the second plurality of rows comprising a second plurality of scan spots based on the second resolution.
